(19) United States
(12) Patent Application Publication
(10) Pub. No.: US 2006/0129571 A1
(43) Pub. Date: Jun. 15, 2006

(54) Data structures for information worms and for information channels incorporating informations worms

(76) Inventors: Theodore Jack London Shrader, Austin, TX (US); David Kingsley Clark, Cedar Park, TX (US); Mary Wier Ferguson, Austin, TX (US); Julie Louise Gilbreath, Liberty Hill, TX (US)

Correspondence Address: Greg Goshorn, P.C., 2110 W. Slaughter lane, SUITE 115-119, AUSTIN, TX, 78748, US

(21) Appl. No.: 11/011,239

(22) Filed: Dec. 14, 2004

(51) Int. Cl. G06F 7/00

(52) U.S. Cl. 707/100

(57) ABSTRACT

Data structures are provided having physical and logical aspects which organize information in a manner which facilitates their replication across networks for the purpose of distributing information. In particular, data structures are provided for information worms and for information channels incorporating information worms. A computer programming product is provided for automated networked distribution of information. The product includes a memory and data, stored on the memory, for representing an information worm, including a worm ID. Also provided are a computing device for automated networked distribution of information and a signal encoded with a computer program for automated networked distribution of information.

### TECHNICAL FIELD

The present invention relates generally to data structures for automated distributing of information across networks and, more specifically, to data structures for information worms and for information channels incorporating information worms.

### BACKGROUND OF THE INVENTION

International Business Machines Corp. (IBM) of Armonk, N.Y. has been at the forefront of new paradigms in business computing. The rise of networking has enabled information to be distributed on an ever-increasing scale. As is typically the case when technology advances, as the new paradigm of networked distribution of information has become well established, companies have been forced to embrace the technology to remain competitive.

The networked distribution of information presents an expanding variety of available information channels (e.g., email, ftp, Web pages, etc.). Over time, information must be updated to retain its usefulness. One widespread approach updating has been to manually distribute updated information through the applicable information channel(s). Unfortunately, the manual approach is very costly in terms of effort, personnel time, and the potential for errors. In addition, the substantial amount of personnel time consumed by manually updating and distributing information takes personnel time away from creating higher quality information.

Another approach, designed to reduce avoid the cost of manual distribution, has been to employ a one-size-fits-all approach. One example of this is broadcast email, in which information is distributed by sending identical or substantially identical emails to multiple recipients. A problem with broadcast emails is that a message, which is relevant to some of the recipients, is not necessarily relevant to other recipients. Relevance to specific recipients is often difficult to ascertain, especially in an automated manner, causing some recipients to receive and be forced to process irrelevant messages. Another example of a one-size-fits-all approach is employing, in multiple Web pages, pointers which all point to a single resource (e.g., an image file, important message, news headline, etc.). The resource is therefore uniformly displayed, or at least accessible, via each of the Web pages. The Web pages are all simultaneously updated by simply updating the resource. A drawback to this approach is that the information is identical in each of the Web pages and must be updated for all of the Web pages simultaneously.

Yet another approach has been to create and maintain a profile for each user, customizing Web pages in accordance with the users' respective profiles. In practice, this typically requires users to expend effort and possibly sacrifice some degree of privacy by submitting information to establish an initial profile, including user-specified preferences, and subsequently logging in to the Web server to retrieve customized Web pages. In addition, user activity can be recorded for use in customizing future Web pages. The user profile approach requires service providers to continuously maintain and protect user records and, despite such efforts, inherently exposes users to a risk of loss of privacy.

Technological improvements are needed which facilitate automated networked distribution of information without the drawbacks of using a one-size-fits-all approach or user-profile approach.

### SUMMARY OF THE INVENTION

Data structures are provided having physical and logical aspects, which organize information in a manner that facilitates their replication across networks for the purpose of distributing information. In particular, data structures are provided for information worms and for information channels incorporating information worms.

A computer programming product is provided for automated networked distribution of information. The product includes a memory and data, stored on the memory, for representing an information worm, including a worm ID. Also provided are a computing device for automated networked distribution of information and a signal encoded with a computer program for automated networked distribution of information.

### BRIEF DESCRIPTION OF THE DRAWINGS

A better understanding of the present invention can be obtained when the following detailed description of the disclosed embodiments is considered in conjunction with the following drawings, in which:

FIG. 1 depicts a block diagram representing an information worm, according to an embodiment of the present invention.

FIG. 2 depicts a block diagram representing an alternate information worm, according to an embodiment of the present invention.

FIG. 3 depicts a block diagram representing another alternate information worm, according to an embodiment of the present invention.

FIG. 4 depicts a block diagram representing an information channel which includes an information worm, according to an embodiment of the present invention.

FIG. 5 depicts a block diagram representing a Web page as an alternate information channel which includes an information worm, according to an embodiment of the present invention.

FIG. 6 depicts a flowchart representing a method for generating Web pages incorporating information worms, according to an embodiment of the present invention.

FIG. 7 depicts a flowchart representing an alternate method for generating Web pages incorporating information worms, according to an embodiment of the present invention.

FIGS. 8A-8B depict a flowchart representing another alternate method for generating Web pages incorporating information worms, according to an embodiment of the present invention.

### DETAILED DESCRIPTION OF THE FIGURES

Although described with particular reference to data structures for information worms and for information channels incorporating information worms, the claimed subject matter can be implemented in any information technology (IT) system in which automated networked distribution of information is desirable. Those with skill in the computing arts will recognize that the disclosed embodiments have relevance to a wide variety of computing environments in addition to those described below. In addition, the methods of the disclosed invention can be implemented in software, hardware, or a combination of software and hardware. For example, the hardware portion can be implemented using specialized logic; by way of further example, the software portion can be stored in a memory and executed by a suitable instruction execution system such as a microprocessor, personal computer (PC), or mainframe.

In the context of this document, a “memory” or “recording medium” can be any means that contains, stores, communicates, propagates, or transports the program and/or data for use by or in conjunction with an instruction execution system, apparatus or device. Memory and recording media can be, but are not limited to, an electronic, magnetic, optical, electromagnetic, infrared, or semiconductor systems, apparatuses, or devices. Memory and recording medium also includes, but is not limited to, for example, the following: a portable computer diskette, a random access memory (RAM), a read-only memory (ROM), an erasable programmable read-only memory (EPROM or flash memory), and a portable compact disk read-only memory, or other suitable medium upon which a program and/or data may be stored.

The term “information worm,” as used hereunder, means a data structure associated with information, having logical and physical aspects, and adapted to be replicated and spread across a network. Such information worms are not destructive as is typically connoted by the term “worm.”

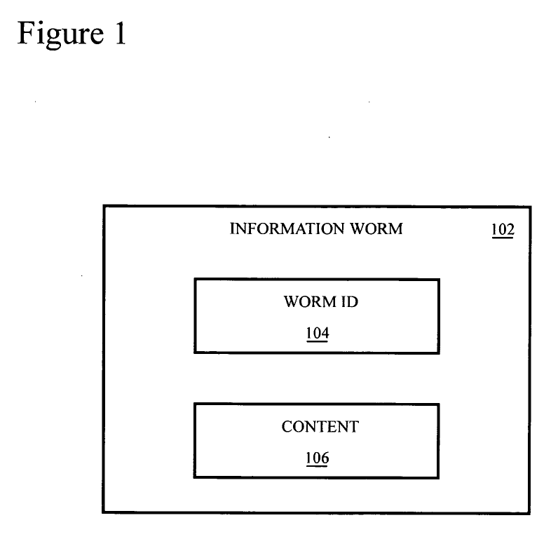

Turning now to the figures, FIG. 1 depicts a block diagram representing an information worm, according to an embodiment of the present invention. The information worm 102 includes a worm ID 104 and a content 106. The worm ID 104 serves to identify the worm 102, and will typically be a unique identifier (e.g., number, character string, etc.). The content 106 can include one or more units of one or more types of information (e.g., text, graphics, audio, data, etc.), one or more pointers to information (e.g., network address, uniform resource locator, uniform resource name, etc.), or one or more areas (e.g., memory block, signal frequency band, etc.) intended for future storage of information, pointers, or a combination thereof.

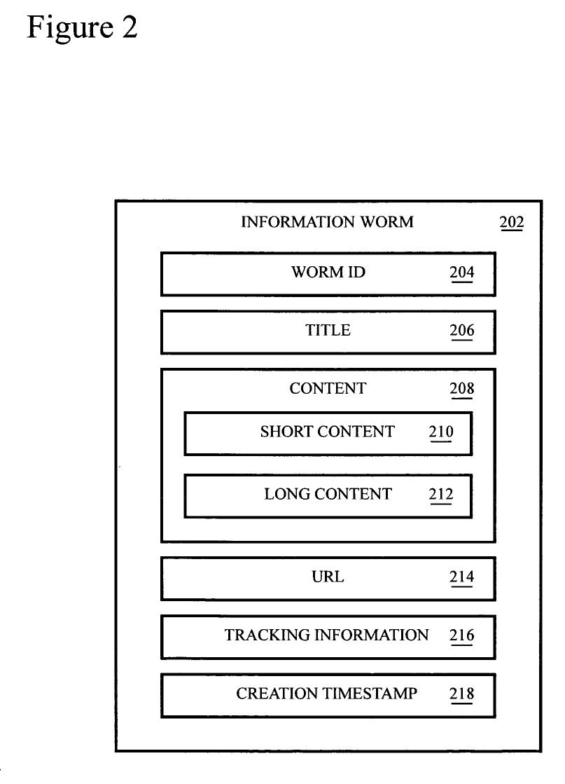

FIG. 2 depicts a block diagram representing an alternate information worm. The information worm 202 includes a worm ID 204 and a title 206. The title 206 is the name of the worm 202, and as such serves to identify the worm 202 in a manner more meaningful to a human reader than the worm ID 204. The information worm 202 also includes content 208, including short content 210 (e.g., one sentence, an abbreviated audio file, an image thumbnail, etc.) and long content 212 (e.g., a column of text, a lengthy audio or video file, a large image, etc.). The information worm 202 is capable of providing either the short content 210 or the long content 212, depending on applicable factors, such as, for example, the evaluation of the worm 202, its selection, the predetermined framework of the information channel to display the worm's content (e.g., Web page), display format instructions associated and replicated with the worm 202, etc.

In this embodiment, the worm 202 also includes a uniform resource locator (URL) 214, which identifies a target resource which is accessible to a user by clicking on a hyperlink associated with the title 206 or content 208. Furthermore, the worm 202 includes tracking information 216, which records or activates tracking tags or triggers upon clicking through to the URL 214. Finally, the information worm 202 includes a creation timestamp 218 corresponding to the date and time the worm 202 was created, which can be useful where the age of the worm 202 is relevant to its evaluation, among other uses. As is the case with other characteristics described in this application in connection with various embodiments of the present invention, the precision of timestamps can vary without departing from the spirit and scope of the appended claims.

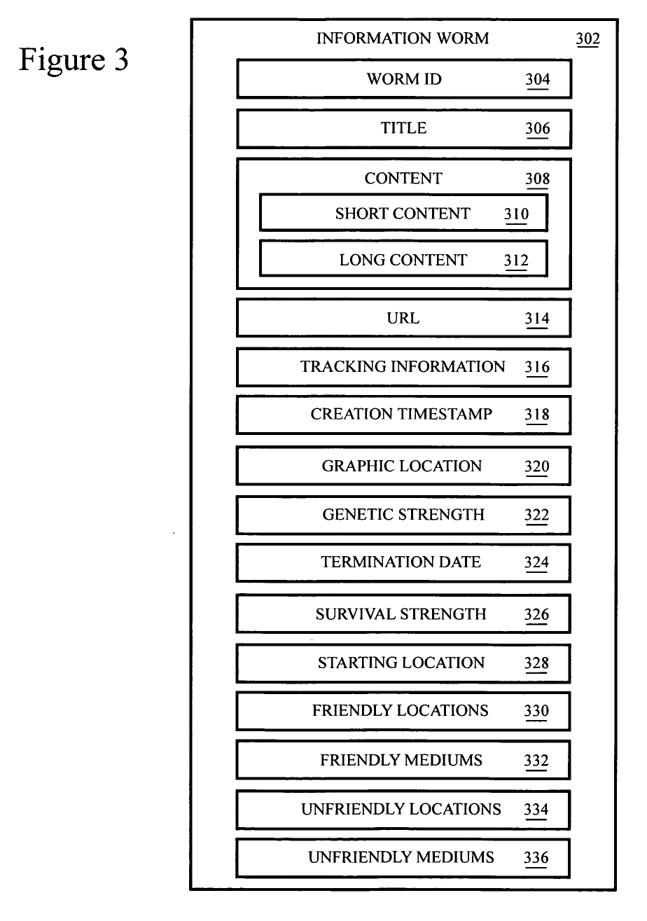

FIG. 3 depicts a block diagram representing another alternate information worm, according to an embodiment of the present invention. The information worm 302 bears some similarity to the information worm 202 shown in FIG. 2. In particular, the elements identified by reference characters 304-318 correspond to the elements identified by reference characters 204-218. The information worm 302 is defined by an extensible markup language (XML) file, which stores data representing the worm's characteristics.

The information worm 302 also includes a graphic location 320, which is an image file associated with the content 308. The worm 302 also possesses a genetic strength 322, which possesses a value between −5 and 5 and helps or hinders the propagation of the worm 302 to a related information channel. As with other specific aspects, this value range can vary according to the implementation of the invention (e.g., as specified by a Web architect, designer, etc.). As a practical matter, administrators can set this value to build or break long chains of consistent content throughout related information channels (e.g., throughout a Web site). The worm 302 further includes a termination date 324, which can be used to set a date beyond which the information worm 302 will no longer be capable of being replicated to distribute information, and will no longer be eligible for distribution through its information channel. One likely use of the termination date 324 is to end promotional offerings.

The information worm 302 also includes a survival strength 326, which corresponds to the tendency of the worm 302 to continue being distributed through an information channel over time. The worm 302 includes a starting location 328, which indicates the information channel via which the information worm 302 is intended to be distributed initially, for example, when its creation timestamp 318 equals the current timestamp.

The worm 302 further includes friendly locations 330 (e.g., URLs, associated XML pages, etc.) in which the worm 302 has a stronger ability to replicate and remain alive. For example, a company's marketing director may want the worm 302 to be frequently incorporated into a specific information channel (e.g., the home page of the company's Web site). The worm 302 also includes friendly mediums 332, which are categories of information channels in which the worm 302 has greater ability to replicate and survive. For example, the marketing director could classify several Web pages as belonging to a Marketing category. An advantage of associating categories with information channels and weighting the categories using worms' friendly mediums is that information regarding categories expected to be relevant in the future can be utilized in designing information worms even though the specific locations of information channels that will come into existence in the future but during the worms' lifetimes is not presently known.

In addition to friendly locations and friendly mediums, the worm 302 also includes unfriendly locations 334 and unfriendly mediums 336. Unfriendly locations 334 are those locations at which the worm 302 cannot survive. Similarly, unfriendly mediums 336 are those categories of information channels in which the worm 302 cannot be incorporated.

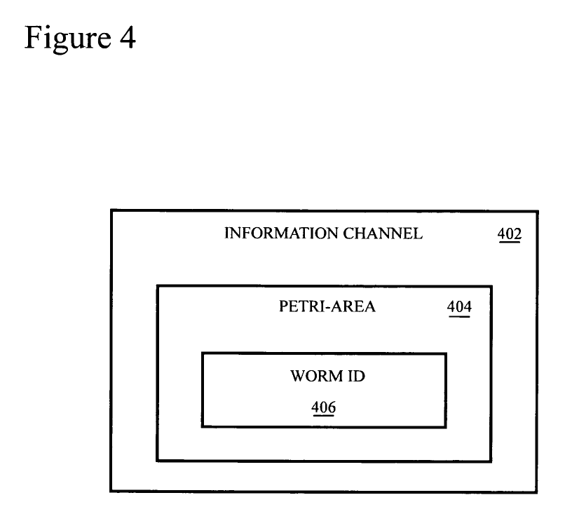

FIG. 4 depicts a block diagram representing an information channel which includes an information worm, according to an embodiment of the present invention. The information channel 402 includes a Petri-area 404, which includes a worm ID 406. In some embodiments, the information channel can incorporate more than one Petri-area, and each Petri-area can be associated with one or more categories. Within the framework of the information channel 402, the Petri-area defines an area for one or more information worms adapted to provide information for distribution via the information channel 402 (e.g., incorporation into, presentation by, accessible through linking, etc.).

The Petri-area 404 essentially provides an area where information worms, such as the worm associated with worm ID 406, can grow and propagate. For example, if the information channel 402 were a Web page, the Petri-area could be defined as a boxed area in which the content associated with three information worms will be displayed. The displayed worms could, for example, relate to a company's product offerings, services, press releases, etc. The specific worm(s) selected to be incorporated into information channel 402 depend on the specific methods of evaluation, selection, and incorporation employed to incorporate worms into the channel 402. In practice, the methods could be selected to increase the likely importance of worms incorporated into a particular information channel. As a result, manual evaluation, selection, and incorporation of worms into information channels is avoided, while limiting or reducing to zero the degree to which appropriate matching of worms to information channels is compromised. Instead of manually evaluating, selecting, and incorporating individual worms into individual information channels, personnel time and effort can be directed to creating information worms with quality content and adding the worms to the pool of worms that an information channel decision-making process or architecture can consider for incorporation into particular information channels.

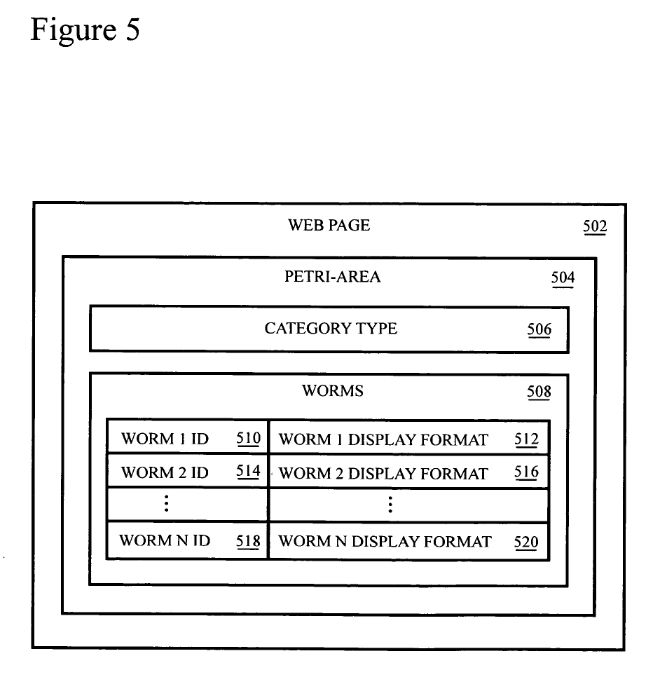

FIG. 5 depicts a block diagram representing a Web page as an alternate information channel which includes an information worm. The Web page 502 includes a Petri-area 504, which includes a category type 506 and information worms 508. The category type 506 (e.g., marketing, developer, administrator, etc.) can include subcategories if desired (e.g., within developer: Java, Web services, Linux, etc.). Depending on the specific implementation, where no category is specified for an information channel, the channel may be considered a member of all categories.

The information worms 508 comprise a plurality of two-element sets, each including a worm ID 510, 514, . . . , 518 and an associated worm display format 512, 516, 520. Each worm display format 512, 516, . . . , 520 governs its display (e.g., presentation, format, appearance, etc.) of its associated worm identified by the corresponding worm ID 510, 514, . . . , 518. For example, the display format 512, 516, . . . , 520 associated with a given worm ID 510, 514, . . . , 518 could determine which component(s) of the worm (e.g., title, short content, long content, worm ID, a combination of worm components, etc.) are displayed. For example, this could allow a Petri-area's first worm to be displayed using larger presentation formatting and its subsequent worms to be displayed using smaller presentation formatting.

Another variation of a Web page incorporating an information worm includes a small Petri-area. In the variation, only the title of the worm and a link to the URL associated with the worm are displayed. Furthermore, some display formats can be utilized by extensible stylesheet language transformations (XSLT) to transform worms into their display forms (e.g., title only, title with short content, graphic only, etc.).

Extensible stylesheet language (XSL) is a language, regulated by W3C, which can define how XML file content is displayed. XML differs from hypertext markup language (HTML) in that XML tags entail no predefined meaning as regards to style or display format. Accordingly, instructions on how to display element content must be provided externally from an XML document. In XML, this can be done using a stylesheet written in XSL. XSL allows specification of display characteristics, enabling identification of document data in an XML file while specifying how to display the data using an XSL stylesheet. XSL also allows specification of tag conventions, which allows conversion of one kind of XML tag into another kind of XML tag. XSL also allows specification of flow objects (also called formatting objects), and the links between such objects, which causes information from the XML file to flow from one area of the page to another automatically if and when the capacity of the first area is exceeded (e.g., continuing a column on a different page, wrapping text around an image, etc.). XSL consists of XSLT, XPath, and XML Formatting Objects.

XSLT is a language (technically an implementation of XML) used to transform the format of XML data into data of other formats on the basis of a set of well-defined rules. For example, XSLT can be utilized to convert XML/XSL documents into HTML that can be displayed by a conventional Web browser. The format into which an XML document can be formatted is, in principle, unlimited (e.g., PDF, JPG, Braille, etc.). XSLT stylesheets work as a series of templates which provide for a specific formatting each time a particular element is encountered. XSLT is often utilized to define a presentation markup (e.g., bold and centered text, underlined and italicized text, etc.) based on rules related to XML structural markup (e.g., title, chapter heading, etc.). Specific elements can be presented independently, which enables automatic production of a table of contents based on the structural markup of a document. XPath is a language for addressing parts of an XML document (i.e., specifying links to or in an XML document). XML Formatting Objects are a language specifying a vocabulary for formatting XML.

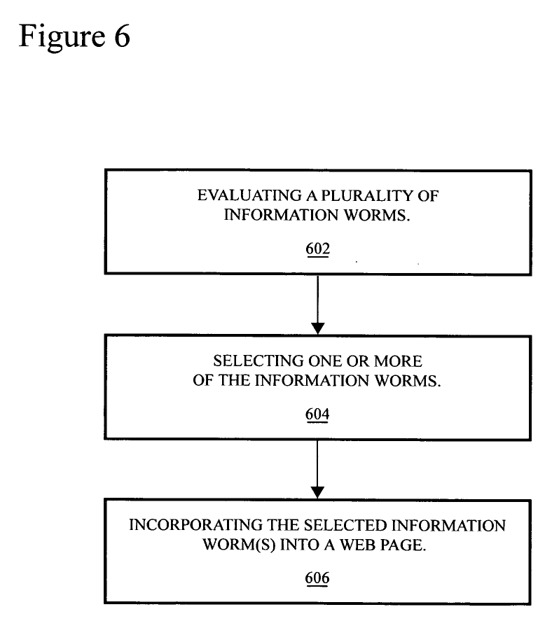

FIG. 6 depicts a flowchart representing a method for generating Web pages incorporating information worms, according to an embodiment of the present invention. A plurality of information worms are evaluated 602; one or more of the information worms are selected 604; and the selected information worm(s) are incorporated 606 into an information channel, such as that depicted in FIG. 4. One approach is to generate Web pages for display by assembling one or more XML files (or other homogeneous-format or heterogeneous-format information resources) and transforming them into a single HTML output page.

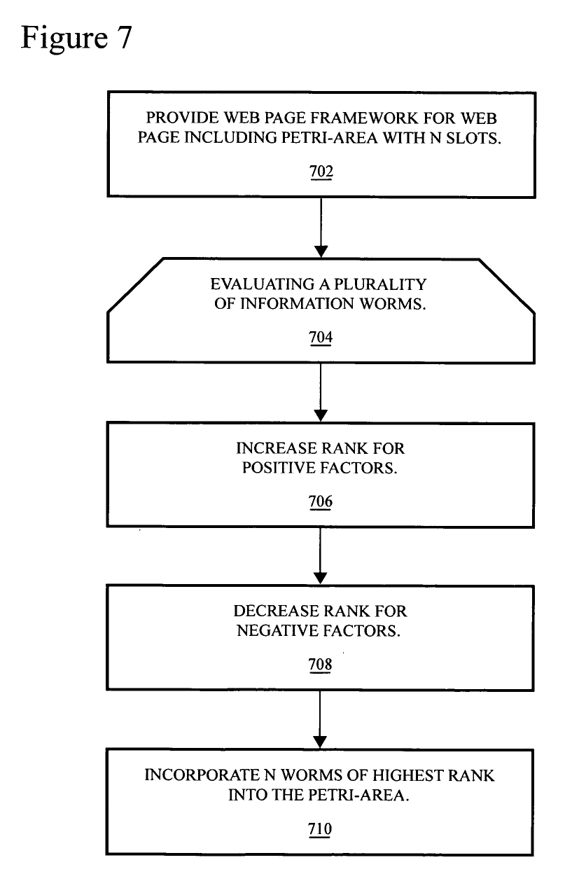

FIG. 7 depicts a flowchart representing an alternate method for generating Web pages incorporating information worms. A Web page framework is provided 702 for a Web page, including a Petri-area with N information worm slots. A plurality of information worms are evaluated 704, assigning a rank to each eligible information worm of the plurality of worms to facilitate subsequent selection of worms for incorporation into the Web page. The evaluation 704 includes increasing 706 a worm's rank for positive factors and decreasing 708 its rank for negative factors. After each eligible worm has had a rank assigned and adjusted, N worms having the N highest ranks are incorporated 710 into the Petri-area of the Web page.

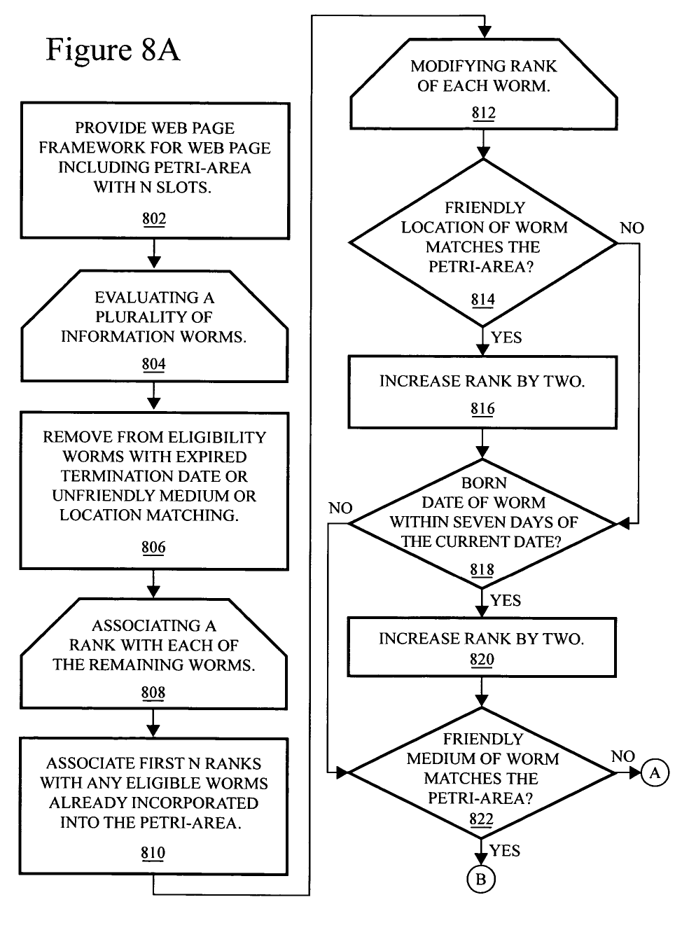

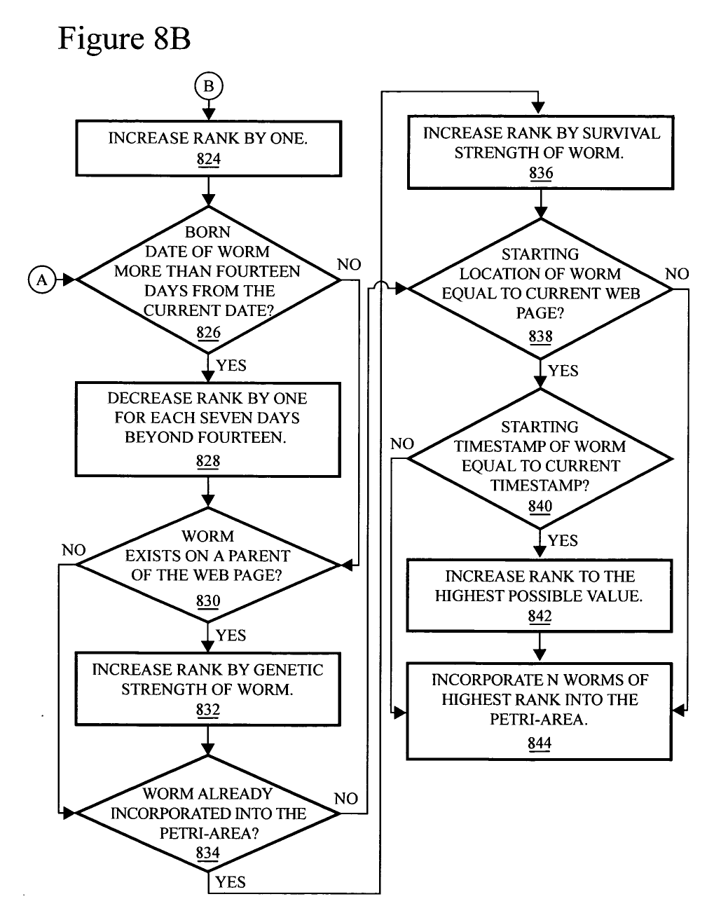

FIGS. 8A-8B depict a flowchart representing another alternate method for generating Web pages incorporating information worms. A Web page framework is provided 802 for a Web page having a Petri-area with N slots for information worms. Each of a plurality of information worms is evaluated 804. Worms having an expired termination date (i.e., a termination date on or before the current date), unfriendly medium matching, or unfriendly location matching are eliminated from eligibility for distribution through the Web page 806.

A rank is associated 808 with each of the information worms remaining eligible. The first (i.e., highest) N ranks are assigned 810 to eligible information worms already incorporated into the Petri-area of the Web page, if and to the extent that such worms are available. The ranks assigned to the eligible worms are modified 812 in accordance with applicable adjustment rules. The ranks of worms having friendly locations matching the Petri-area 814 are increased by two 816. The ranks of worms having born dates (i.e., creation timestamps) within seven days of the current date 818 are increased by two 820. The ranks of worms having friendly mediums matching the Petri-area 822 are increased by one 824. In this embodiment, friendly locations possess a greater weight because they are more specific by nature than friendly mediums. The ranks of worms having born dates more than fourteen days before the current date 826 are decreased by one for each seven days, or part thereof, by which the born date precedes the current date by more than fourteen days 828.

The ranks of worms already existing on a parent of the Web page 830 are increased by the worms' respective genetic strengths 832. The ranks of worms already incorporated into the Petri-area of the Web page 834 are increased by the worms' respective survival strengths 836. The ranks of worms having a starting location equal to the current Web page 838 and a starting timestamp equal to the current timestamp 840 are increased to the highest possible value 842. For some embodiments, the timestamp check can be considered to be equal if the starting timestamp is within some period of time (e.g., 12 hours) of the current timestamp. The N highest-ranking worms are then incorporated into the Petri-area of the Web page 844.

Where a tie between the ranks of two or more information worms must be broken, a method can incorporate any desired approach. For example, the tie can be broken randomly, arbitrarily, or favoring certain characteristics (e.g., existing, younger, genetically stronger, etc.).

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified blocks performed in the same or a different order. For example, as contrasted with the Web page depicted in FIG. 6, a Web page can incorporate a worm having multiple display formats, and a plurality of worms can be defined by a single display format. As another example, a method for generating a Web page incorporating one or more of a plurality of worms can include, (1) initially, randomly selecting one of the plurality of worms, (2) subsequently to selecting, evaluating the worm and assigning a rank to the worm accordingly, (3) subsequently to assigning the rank, if the rank is above a threshold T, incorporating the worm into the Web page, (4) otherwise, repeating steps (1)-(3) for another of the plurality of worms, and so on until a sufficient number of worms have been incorporated into the Web page. As yet another example, an information channel could have a threshold T, but not a fixed number of slots N. As a result, the number of information worms ultimately incorporated into the information channel would depend only upon the final ranks of the eligible information worms. In addition, whether a particular worm is incorporated into the information channel would depend only upon the final rank of the particular worm, and not on the final ranks of other eligible worms. As a further example, a method can incorporate default rules for exception handling, such as utilizing default worms for occasions when no eligible worms have propagated or survived to reach a particular information channel's Petri-area.

We claim:

1. A computer programming product for automated networked distribution of information, the product comprising:
a memory;
data, stored on the memory, for representing an information worm, comprising:
data, stored on the memory, for representing a worm ID.

2. The product of claim 1, further comprising:
data, stored on the memory, for representing an information channel;
wherein the information channel includes the information worm.

3. The product of claim 2, wherein the information channel comprises a Web page, the product further comprising:
data, stored on the memory, for representing a Petri-area included as part of the Web page.

4. The product of claim 3, further comprising:
data, stored on the memory, for representing a category type included as part of the Petri-area;
wherein the data for representing the information worm represents one or more information worms, each comprising:
a worm ID; and
a worm display format.

5. The product of claim 1, wherein the data for representing the information worm further comprises:
data, stored on the memory, for representing a title;
data, stored on the memory, for representing content comprising short content and long content;
data, stored on the memory, for representing a uniform resource locator;
data, stored on the memory, for representing tracking information;
data, stored on the memory, for representing a creation timestamp.

6. The product of claim 5, wherein the data for representing the information worm further comprises:
data, stored on the memory, for representing a graphic location;
data, stored on the memory, for representing a genetic strength;
data, stored on the memory, for representing a termination date;
data, stored on the memory, for representing a survival strength;
data, stored on the memory, for representing a starting location;
data, stored on the memory, for representing friendly locations;
data, stored on the memory, for representing friendly mediums;
data, stored on the memory, for representing unfriendly locations;
data, stored on the memory, for representing unfriendly mediums.

7. The product of claim 1, further comprising:
data, stored on the memory, for representing one or more other information worms, each comprising:
data, stored on the memory, for representing a worm ID.

8. A computing device for automated networked distribution of information, the device comprising:
a memory;
data, stored on the memory, for representing an information worm, comprising:
data, stored on the memory, for representing a worm ID.

9. The device of claim 8, further comprising:
data, stored on the memory, for representing an information channel;
wherein the information channel includes the information worm.

10. The device of claim 9, wherein the information channel comprises a Web page, the device further comprising:
data, stored on the memory, for representing a Petri-area included as part of the Web page.

11. The device of claim 10, further comprising:
data, stored on the memory, for representing a category type included as part of the Petri-area;
wherein the data for representing the information worm represents one or more information worms, each comprising:
a worm ID; and
a worm display format.

12. The device of claim 8, wherein the data for representing the information worm further comprises:
data, stored on the memory, for representing a title;
data, stored on the memory, for representing content comprising short content and long content;
data, stored on the memory, for representing a uniform resource locator;
data, stored on the memory, for representing tracking information;
data, stored on the memory, for representing a creation timestamp.

13. The device of claim 12, wherein the data for representing the information worm further comprises:
data, stored on the memory, for representing a graphic location;
data, stored on the memory, for representing a genetic strength;
data, stored on the memory, for representing a termination date;
data, stored on the memory, for representing a survival strength;
data, stored on the memory, for representing a starting location;
data, stored on the memory, for representing friendly locations;
data, stored on the memory, for representing friendly mediums;
data, stored on the memory, for representing unfriendly locations;
data, stored on the memory, for representing unfriendly mediums.

14. A signal encoded with a data structure for automated networked distribution of information, the signal comprising:
data, encoded on the signal, for representing an information worm, comprising:
data, encoded on the signal, for representing a worm ID.

15. The signal of claim 14, further comprising:
data, encoded on the signal, for representing an information channel;
wherein the information channel includes the information worm.

16. The signal of claim 15, wherein the information channel comprises a Web page, the signal further comprising:
data, encoded on the signal, for representing a Petri-area included as part of the Web page.

17. The signal of claim 16, further comprising:
data, encoded on the signal, for representing a category type included as part of the Petri-area;
wherein the data for representing the information worm represents one or more information worms, each comprising:
a worm ID; and
a worm display format.

18. The signal of claim 14, wherein the data for representing the information worm further comprises:
data, encoded on the signal, for representing a title;
data, encoded on the signal, for representing content comprising short content and long content;
data, encoded on the signal, for representing a uniform resource locator;
data, encoded on the signal, for representing tracking information;
data, encoded on the signal, for representing a creation timestamp.

19. The signal of claim 18, wherein the data for representing the information worm further comprises:
data, encoded on the signal, for representing a graphic location;
data, encoded on the signal, for representing a genetic strength;
data, encoded on the signal, for representing a termination date;
data, encoded on the signal, for representing a survival strength;
data, encoded on the signal, for representing a starting location;
data, encoded on the signal, for representing friendly locations;
data, encoded on the signal, for representing friendly mediums;
data, encoded on the signal, for representing unfriendly locations;
data, encoded on the signal, for representing unfriendly mediums.

20. The signal of claim 14, further comprising:
data, encoded on the signal, for representing one or more other information worms, each comprising:
data, encoded on the signal, for representing a worm ID.
